(19) United States
(12) Patent Application Publication
(10) Pub. No.: US 2010/0322626 A1
(43) Pub. Date: Dec. 23, 2010

(54) MULTIPLE PASSIVE OPTICAL NETWORK SYSTEM

(75) Inventors: Jong-deog Kim, Jeollanam-do (KR); Bin-yeong Yoon, Daejeon-si (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-si (KR)

(21) Appl. No.: 12/677,226

(22) PCT Filed: May 22, 2008
(86) PCT No.: PCT/KR08/02857

§ 371 Date: Mar. 9, 2010

(30) Foreign Application Priority Data
Sep. 10, 2007 (KR) 10-2007-0091722

(51) Int. Cl. H04B 10/20

(52) U.S. Cl. 398/63

(57) ABSTRACT

Disclosed are a multiple passive optical network system and a wavelength splitter/combiner used in the same. The multiple passive optical network (PON) system includes a first PON, and a second PON which provides a service different in speed and capacity from the first PON while partially sharing network resources with the first PON. Thereby a subscriber can receive service through a network having a desired capacity and speed.

### TECHNICAL FIELD

The present invention relates to optical network technology and more particularly to a Passive Optical Network (PON) technology which can be used in building Fiber-To-The-Home (FTTH).

### BACKGROUND ART

Today, Fiber-To-The-Home (FTTH) technology that provides a next-generation internet protocol television (IP-TV) service is increasingly deployed. Among various Passive Optical Network (PON) technologies for deploying FTTH, Ethernet PON (EPON) and gigabit-capable PON, which can be built at a low initial cost, are being applied to commercial networks around Japan and the US, respectively. Further, Wavelength-Division Multiplexing (WDM)-PONs and 10G EPON/GPONs capable of supporting gigabit or more data per channel (per home) have been developed as a next-generation FTTH technology.

In a general configuration of the EPON/GPON based on Time Division Multiple Access (TDMA)-PON technology, a central office (or a telephone office) is provided with an Optical Line Termination (OLT) for transmitting, receiving and processing data, and a subscriber group (office or home) is provided with an Optical Network Unit (ONU) for transmitting, receiving and processing data. Here, the OLT and the ONU are connected to each other by an optical fiber through an optical splitter, so that uplink and downlink optical signals can be transmitted and received therebetween. For reference, the ONU is also called an Optical Network Terminal (ONT).

Standards for the EPON technology are based on Institute of Electrical and Electronics Engineers (IEEE) 802.3, and standards for the GPON technology are based on International Telecommunications Union (ITU) G.984. For bidirectional communication through one optical fiber, an uplink wavelength is standardized at 1310 nm, and a downlink wavelength is standardized at 1490 nm. Further, an extra wavelength is used for a video overlay so as to support an existing satellite broadcast service, and a cable television (CATV) service, etc. The downlink wavelength for the video overlay has not been laid out yet in the standards document, but uses 1550 nm as a provisionally acceptable wavelength. In the next-generation FTTH technology, standardization of the 10G EPON has been in progress by IEEE 802.3av, and standardization of 10G GPON and WDM-PON has been undergoing examination and discussion at the full service access network (FSAN) forum.

FIG. 1 shows the foregoing general Time-Division Multiplexing (TDM) Passive Optical Network (PON).

Wavelengths (1310 nm) λ1 for an uplink transmission signal generated in the ONUs 10a, 10b are combined by each of the optical fibers 20a, 20b in the optical splitter 11a, 11b, and then sent to the OLTs 30a, 30b of the central office (CO). Further, an analog data wavelength (1550 nm) λ3 for the video overlay and a digital data wavelength (1490 nm) λ2 generated as a downlink transmission signal in each of the OLTs 30a, 30b are split as many as n optical intensities in the optical splitter 11a, 11b via the optical fibers 20a, 20b and then sent to the ONU 10a, 10b.

Generally, the split number n of the optical splitter is ‘16’, ‘32’, or ‘64’ with regard to one OLT. Also, a general transmission distance between the OLT and the ONU is about 10 km to 20 km. In general, the optical fiber is installed in the form of a fiber bundle 20 from the central office to a subscriber area, and the optical splitter 11a, 11b is provided as a remote node for the optical split corresponding to a plurality of subscribers in an area near the subscribers.

Meanwhile, in building a network for high-speed internet service, EPON/GPONs will be replaced by WDM-PONs or 10G EPON/GPONs as the current technology of various digital subscriber lines (xDSL) has been replaced by the FTTH technology based on the EPON/GPON. However, it is expected that demand for higher bandwidth will gradually decrease as commercialization of FTTH, which is capable of providing good-quality high-speed internet service. Accordingly, it is expected that demand for a low capacity/low cost service and a high capacity/high cost service per channel (per home) will be mixed in one area, and thus there will be a need for a multiple FTTH technology that can provide a service mixture for both the present generation and the next-generation.

### DISCLOSURE OF INVENTION

1. Technical Solution

Therefore, the present invention is conceived to solve the above problems of the conventional techniques, and an aspect of the present invention to provide a multiple passive optical network that is capable of offering a low speed/low data capacity service and a high speed/high data capacity service.

Another aspect of the present invention is to provide a Wavelength Division Multiplexing (WDM) coupler that has an improved structure necessary for the multiple passive optical network.

2. Advantageous Effects

According to the present invention, a second passive optical network providing a high speed/high capacity service is applied to a first passive optical network providing a low speed/low data capacity service, so that not only can a subscriber select their desired network service but also network resources are shared to prevent a resource waste. In other words, the present invention provides an economical and efficient fiber-to-the-home (FTTH) infrastructure.

Further, according to the present invention, a wavelength to be assigned is easily split and combined in different passive optical networks, so that the different passive optical networks can be applied to each other.

### BRIEF DESCRIPTION OF THE DRAWINGS

The above and other objects, features and advantages of the present invention will become apparent from the following description of preferred embodiments given in conjunction with the accompanying drawings, in which:

FIG. 1 shows a general Time-Division Multiplexing (TDM) Passive Optical Network (PON);

FIG. 2 shows a multiple passive optical network according to an exemplary embodiment of the present invention;

FIG. 3 shows the multiple passive optical network according to another exemplary embodiment of the present invention;

FIG. 4 shows wavelength assignment for the multiple passive optical network according to an exemplary embodiment of the present invention;

FIG. 5 shows an example of a wavelength splitter/combiner;

FIG. 6 shows a wavelength splitter/combiner according to an exemplary embodiment of the present invention;

FIG. 7 shows the wavelength splitter/combiner according to another exemplary embodiment of the present invention; and

FIG. 8 shows the wavelength splitter/combiner according to a third exemplary embodiment of the present invention.

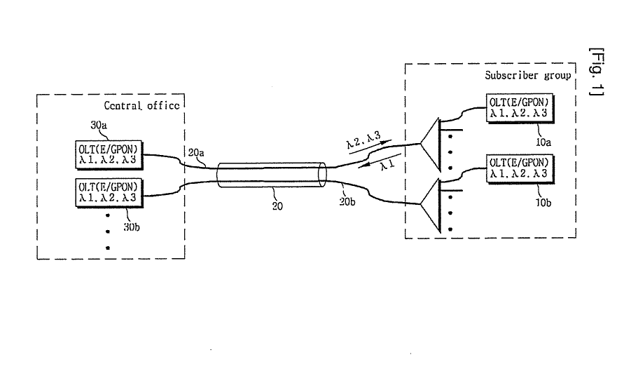

### BEST MODE FOR CARRYING OUT THE INVENTION

In accordance with one aspect of the present invention, a multiple Passive Optical Network (PON) system includes a first PON, and a second PON which provides a service different in speed and capacity from the first PON while partially sharing network resources with the first PON.

The first PON may include at least one first optical line termination (OLT), a plurality of first optical network units (ONUs) corresponding to the first OLT, and a first remote node which separates a downlink transmission wavelength from the first OLT to the plurality of first ONUs and sends uplink transmission wavelengths from the plurality of first ONUs to the first OLT; and the second PON includes at least one second OLT, a plurality of second ONUs corresponding to the second OLT, and a second remote node which separates a downlink transmission wavelength from the second OLT to the plurality of second ONUs and sends uplink transmission wavelengths from the plurality of second ONUs to the first OLT, wherein an optical fiber is shared in at least one section between a side including the first OLT and the plurality of first ONUs corresponding to the first OLT and a side including the second OLT and the plurality of second ONUs corresponding to the second OLT to transmit and receive the uplink and downlink transmission wavelengths.

The second PON may include: a first splitter/combiner which splits or combines the uplink and downlink transmission wavelengths to be transmitted and received in the first OLT and the uplink and downlink transmission wavelengths to be transmitted and received in the second OLT through the shared optical fiber, and a second splitter/combiner which splits or combiners the uplink and downlink transmission wavelengths to be transmitted and received in the first ONUs and the uplink and downlink transmission wavelengths to be transmitted and received in the second ONUs through the shared optical fiber.

In accordance with another aspect of the present invention, a wavelength splitter/combiner includes: a dual filter including a first thin film filter and a second thin film filter, which are placed symmetrically to each other, to transmit or reflect wavelengths according to the wavelengths; at least one first input/output port placed at a side of the first thin film filter; and at least one second input/output port placed at a side of the second thin film filter, wherein the dual filter includes a wavelength-division multiplexing (WDM) coupler that transmits and reflects uplink and downlink transmission wavelengths assigned to a first passive optical network (PON) and uplink and downlink transmission wavelengths assigned to a second PON different from the first PON, which are incident to the input/output ports, such that the wavelength are output through the corresponding input/output ports to split or combined.

### MODE FOR THE INVENTION

Exemplary embodiments of the present invention will hereinafter be described in detail with reference to the accompanying drawings, to thereby fully convey the scope of the invention to those skilled in the art.

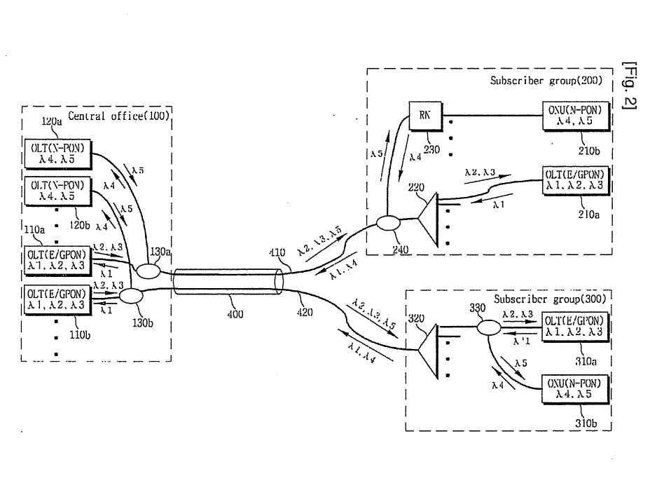

FIG. 2 shows a multiple Passive Optical Network (PON) according to an exemplary embodiment of the present invention.

In this embodiment, the multiple passive optical network (PON) includes first and second passive optical networks which support services with different speeds and capacities. For example, the first PON is a network capable of supporting a low-speed and low-capacity service, and an Ethernet Passive Optical Network (EPON) or a Gigabit-capable Passive Optical Network (GPON) may be employed as the first PON. The second PON is a next-generation network capable of supporting a high-speed and high-capacity service, and 10G EPON, 10G GPM, or Wavelength-Division Multiplexing (WDM) PON may be used as the second PON.

Referring to FIG. 2, the first PON is illustrated as an E/GPON, and the second PON is illustrated as an N-PON (next-generation PON). Herein, the N-PON may include a 10G EPON, 10G GPON or WDM-PON.

A central office (CO) 100 includes an Optical Line Termination (OLT) 100a, 110b for the first PON, and an optical line termination (OLT) 120a, 120b for the second PON. Also, a subscriber group 200, 300 includes an Optical Network Unit (ONU) 210a, 310a for the first PON, and an optical network unit (ONU) 210b, 310b for the second PON. The OLT 110a corresponds to the ONUs 210a, and transmits and receives a wavelength λ1 for an uplink transmission signal, a wavelength λ2 for a downlink transmission signal, and a wavelength λ3 for a video overlay with respect to the ONUs 210a. Likewise, the OLT 120a transmits and receives a wavelength λ4 for an uplink transmission signal and a wavelength λ5 for a downlink transmission signal with respect to the ONUs 210b. Also, the OLT 110b corresponds to the ONUs 310a, and transmits and receives the wavelength λ1 for the uplink transmission signal, the wavelength λ2 for the downlink transmission signal, and the wavelength λ3 for the video overlay with respect to the ONUs 310a. Likewise, the OLT 120b transmits and receives the wavelength λ4 for the uplink transmission signal and the wavelength λ5 for the downlink transmission signal with respect to the ONUs 310b. Here, it is assumed that the wavelength λ3 for the video overlay is used in the first PON, but is not limited thereto.

According to an aspect of the present invention, network resources are partially shared between the first PON and the second PON. In this embodiment, an optical fiber used as a transmission medium is at least partially shared between the first PON and the second PON. Hereinafter a multiple passive optical network system for sharing at least a part of the optical fiber will be described in detail.

The central office 100 includes a first splitter/combiner 130a, 130b. The first splitter/combiner 130a splits or combines the wavelengths λ1, λ2 and λ3 assigned to the first PON and the wavelengths λ4 and λ5 assigned to the second PON. In more detail, the first splitter/combiner 130a combines the downlink transmission wavelength λ2 and the video overlay wavelength λ3, which are received from the OLT 110a, with the downlink transmission wavelength λ5, which is received from the OLT 120a, and then sends the combined wavelengths to a first subscriber group 200 through an optical fiber 410 of a fiber bundle 400 in an optical distribution network (ODN). Further, the first splitter/combiner 130a splits the uplink transmission wavelengths λ1 and λ4 received from the first subscriber 200 through the optical fiber 410, and then sends the wavelength λ1 and the wavelength λ4 to the OLT 110a and the OLT 120a, respectively. Similarly, the first splitter/combiner 130b performs the same function as the first splitter/combiner 130a at this location.

The first subscriber group 200 includes a second splitter/combiner 240. Like the first splitter/combiner 130a, 130b, the second splitter/combiner 240 splits or combines the wavelengths λ1, λ2 and λ3 assigned to the first PON and the wavelengths λ4 and λ5 assigned to the second PON. In more detail, the second splitter/combiner 240 combines the uplink transmission wavelength λ1 received from a first remote node 220 and the uplink transmission wavelength λ4 received from a second remote node 230, and sends the combined wavelengths to the central office 100 through the optical fiber 410. Further, the second splitter/combiner 240 splits the wavelengths λ2, λ3 and λ5 received through the optical fiber 410, thereby sending the wavelengths λ2 and λ3 to the first remote mode 220 and the wavelength λ5 to the second remote node 230. Here, a WDM coupler may be used as the second splitter/combiner 240.

The first remote node 220 branches the downlink transmission wavelength λ2 and the video overlay wavelength λ3, which are split by the second splitter/combiner 240, into a plurality of ONUs 210a, and sends the uplink transmission wavelength λ1 from the plurality of ONUs 210a to the second splitter/combiner 240. Further, the second remote node 230 branches the downlink transmission wavelength λ5, which is split by the second splitter/combiner 240, to a plurality of ONUs 210b, and sends the uplink transmission wavelength λ4 from the plurality of ONUs 210b to the second splitter/combiner 240. If the second PON is a 10G TDMA-PON (10G EPON or 10G GPON), a power splitter may be employed as the second remote node 230. If the second PON is the WDM-PON, an Arrayed Waveguide Grating (AWG) may be used as the second remote node 230.

Meanwhile, according to another aspect of the present invention, the second subscriber group 300 is different from the first subscriber group 200. The ONUs 310a and the ONUs 310b of the second subscriber group 300 operate corresponding to the OLT 110b and the OLT 120b of the central office 100, respectively. The first splitter/combiner 130b of the central office has the same function as the above-described first splitter/combiner 130a, and thus repetitive descriptions thereof will be omitted.

The second subscriber group 300 includes a remote node 320 and a second splitter/combiner 330. The remote node 320 branches off the downlink transmission wavelengths λ2 and λ5 and the video overlay wavelength λ3, which are received from the central office 100 through the optical fiber 420, and sends the uplink transmission wavelengths λ1 and λ4 from the ONUs 310a and the ONUs 310b at branched locations to the central office 100 through the optical fiber 420. Here, it is preferable but not necessary that the power splitter be used as the remote node 320.

The second splitter/combiner 330 is provided at each location branched from the power splitter 320, and splits or combines the wavelengths λ1, λ2 and λ3 assigned to the first PON and the wavelengths λ4 and λ5 assigned to the second PON. In more detail, the second splitter/combiner 330 splits the branched downlink transmission wavelengths λ2, λ3 and λ5, and sends the wavelengths λ2 and λ3 to the ONU 310a and the wavelength λ5 to the ONU 310b. Further, the second splitter/combiner 330 combines the uplink transmission wavelength λ1 transmitted from the ONU 310a and the uplink transmission wavelength λ4 transmitted from the ONU 310b, and sends the combined wavelengths to the power splitter 320.

When comparing the first subscriber group 200 and the second subscriber group 300, the first subscriber group 200 employs the WDM coupler 240 provided in front of the first remote node 220 for the first PON so that the wavelengths λ4 and λ5 for the second PON are split from the wavelengths λ1, λ2 and λ3 for the first PON; and the second subscriber group 300 uses the WDM couplers 330 each located on branches toward the subscribers from the remote node 320 for the first PON so that the wavelengths λ2 and λ3 for the first PON and the wavelengths λ4 and λ5 for the second PON are split from each other.

The first subscriber group 200 is useful if the number of branches from the power splitter 220 is relatively large or if a subscriber group for the second PON is locally separated from a subscriber group for the first PON. The second subscriber group 300 is useful to minimize installation of the optical fiber for the second PON from the remote node 320 to the subscriber.

FIG. 3 shows a multiple passive optical network according to another exemplary embodiment of the present invention.

As compared with the multiple PON shown in FIG. 2, the multiple PON shown in FIG. 3 additionally includes a branching unit 140 in the central office 100. In this embodiment, the branching unit 140 is the power splitter. The branching unit 140 branches the downlink transmission wavelength λ5 to the first splitter/combiner 130a, 130b, and also sends the uplink transmission wavelength λ4 branched in the first splitter/combiner 130a, 130b to the OLT 120. This is necessary since the OLT 120 of the second PON has a larger subscriber capacity as a next-generation PON. In other words, the number of branches from the branching unit 140 is determined according to performance of the second PON.

As shown in FIGS. 2 and 3, a video overlay function is typically provided along with the EPON/GPON, but may be provided along with the next-generation PON (N-PON), if necessary. Further, the WDM couplers 130a, 130b, 240, 330 for combination and division of a wavelength band are necessary for the multiple PON, and they can be manufactured to have an insertion loss within about 0.7 dB. Thus, it is preferable but not indispensable that the uplink/downlink optical signals be complemented to an insertion loss within about 1.5 dB in the EPON/GPON.

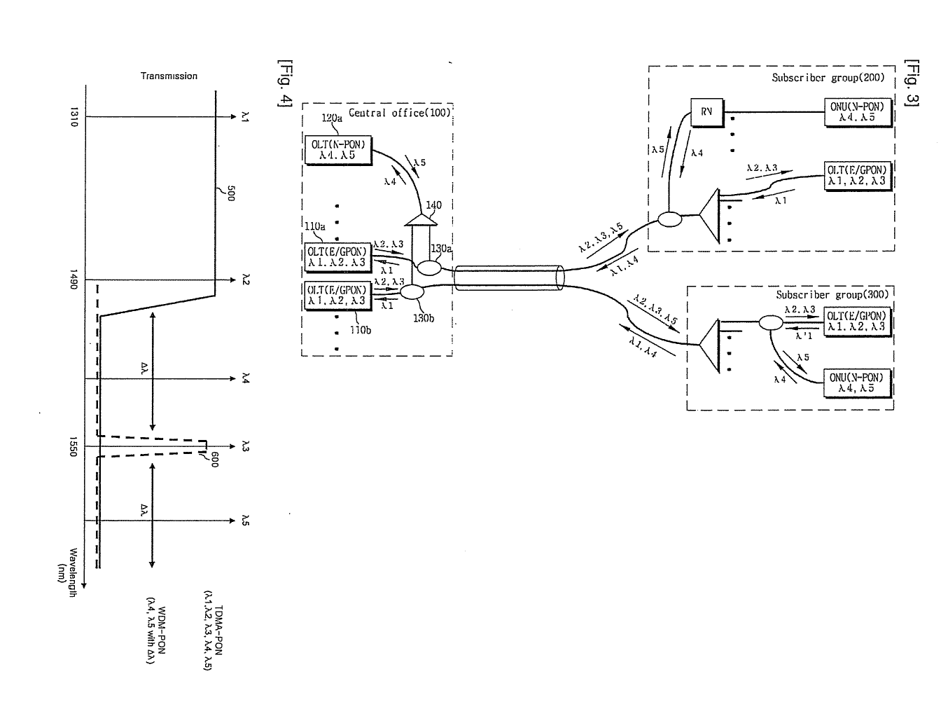

FIG. 4 shows wavelength assignment for the multiple passive optical network according to an exemplary embodiment of the present invention.

FIG. 4 is a graph explaining transmission properties of a WDM filter and a wavelength band assignment method for the N-PON adapted to the foregoing multiple PON.

Here, λ1 and λ2 indicate a standard wavelength band for bidirectional communication defined in the EPON/GPON, in which λ1 and λ2 have center wavelengths of 1310 nm and 1490 nm, respectively. Typically, λ3 for the video overlay is 1550 nm, but this has not been stated yet in the EPON/GPON standards document. Further, the wavelength for the next-generation (N-PON) has not been determined yet, but has recently undergone discussion in Full Service Access Network (FSAN) and Institute of Electrical and Electronics Engineers (IEEE) while considering several possibilities. In this specification, as shown in FIG. 4, the wavelength band for the N-PON will be proposed regardless of the standardization discussion, which is different from the standard wavelength for the EPON/GPON.

Herein, λ4 indicates a certain center wavelength for uplink or downlink transmission selected in the range of 1510 nm to 1540 nm, and λ5 indicates a certain center wavelength for uplink or downlink transmission selected in the range of wavelengths longer than λ3. For convenience, it will be assumed that λ4 is a center wavelength for the uplink transmission and λ5 is a center wavelength for the downlink transmission, thereby matching with the foregoing descriptions. In the WDM-PON, it is necessary to use all of a wide wavelength band (refer to Δλ in FIG. 4) for all a plurality of wavelength channels, which is distinctively wider than the uplink wavelengths λ1 and λ2 for the EPON/GPON and the wavelength λ3 for the video overlay.

For reference, the wavelength assignment is described for explaining the multiple passive optical network and the WDM filter according to the present invention.

In FIG. 4, solid line 500 indicates transmission depending on wavelength, which shows the transmission properties of a WDM coupler for splitting the wavelengths λ1 and λ2 for the EPON/GPON and the wavelengths λ3, λ4 and λ5 for the video overlay. On the other hand, dotted line 600 shows the transmission properties of the WDM coupler for splitting the wavelength λ3 for the video overlay from the wavelengths λ3, λ4 and λ5 represented by the solid line 500 so as to provide a CATV service based on the video overlay to the subscribers of the EPON/GPON. In the case of the WDM coupler using the optical filter, the width of transmission and reflection wavelength edges can be adjusted to have a separation of about 10 nm.

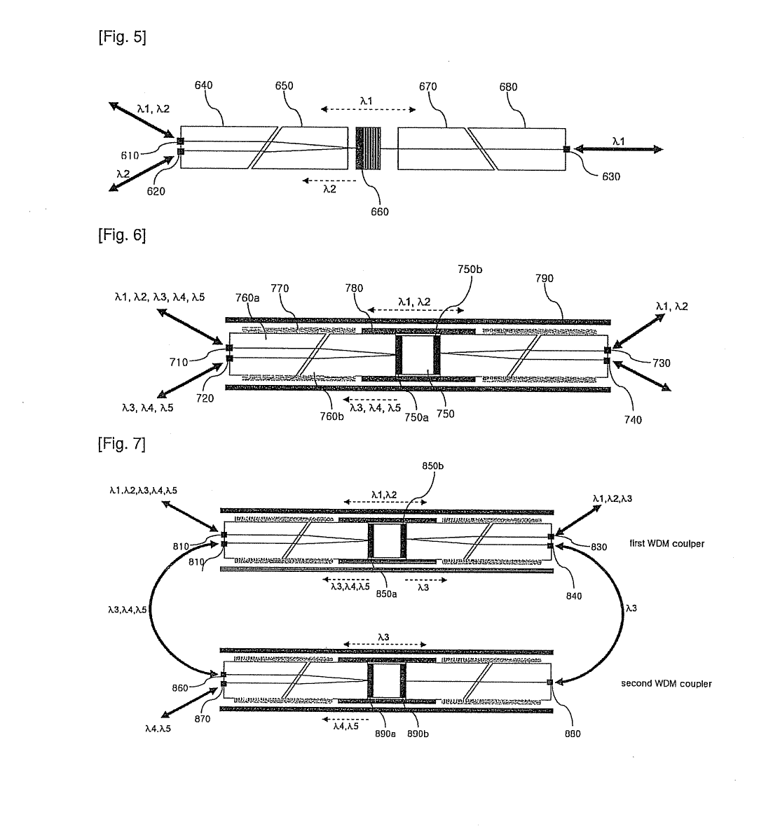

Meanwhile, general WDM couplers have a different assembly method, but fundamentally serve as the wavelength splitter/combiner as shown in FIG. 5. The wavelengths λ1 and λ2 input to an input/output port 610 are split into the wavelength λ1 and the wavelength λ2 through a thin film filter 660 via a dual fiber collimator having a dual fiber ferrule 640 and a green lens 650, in which the wavelength λ1 is transmitted and the wavelength λ2 is reflected. The reflective wavelength λ2 passes through the green lens 650 and the dual fiber ferrule 640 again and is then output through an input/output port 620. The transmitted wavelength λ1 is combined in a fiber collimator having a green lens 670 and a single fiber ferrule 640, and is then output through an input/output port 630.

Since operation is performed in the same way with regard to the reverse direction, bidirectional communication is possible at the same wavelength. If there is no wavelength for the video overlay, the EPON/GPON may use the WDM coupler having a general structure as shown in FIG. 4 along with an optical thin film filter having proper transmission and reflection properties.

FIG. 6 shows a WDM coupler according to an exemplary embodiment of the present invention.

The WDM coupler according to this embodiment includes a left dual-fiber collimator that has a dual fiber ferrule 760a, a green lens 760b and a fixing tube 770; a dual thin film filter 750 that has thin film filters 750a, 750b formed at opposite sides of a transparent material and having the same properties; a right dual-fiber collimator that has the same structure as the left one; an optical alignment assembling tube 780; and an outer housing 790. These components are assembled as follows. A moderate amount of epoxy is applied to the surfaces of the green lenses of the dual fiber collimators, and then the left dual-fiber collimator, the dual thin film filter 750, the assembling tube 780, and the right dual-fiber collimator are assembled in order from bottom to top. The assembled elements are cured in the state that they are aligned to achieve optimum transmission and reflection properties between the optical fibers, and then they are encased in the outer housing 790 and cured again. Here, the assembling method itself is not directly related to the present invention.

The WDM coupler shown in FIG. 6 is characteristic in that it first has a left and right symmetrical structure with respect to the input/output port and second has a dual filtering structure with respect to the transmission wavelength. As a first characteristic, input/output properties of the wavelength according to the symmetrical structure will be described below. When signals having the wavelengths λ1, λ2, λ3, λ4 and λ5 are bi-directionally input to the input/output port 710, the wavelengths λ3, λ4 and λ5 are reflected from the thin film filter 750a and output to the input/output port 720, and the wavelengths λ1 and λ2 are output to the input/output port 730 through the thin film filters 750a and 750b of the dual thin film filter 750. When the wavelengths λ1, λ2, λ3, λ4 and λ5 are input to the input/output port 730 in the same direction, the wavelengths λ1 and λ2 transit the dual thin film filter 750 and are output to the input/output port 710, and the wavelengths λ3, λ4 and λ5 are reflected from the thin film filter 750b and output to the input/output port 740. Operation is performed in the same way with regard to the reverse direction.

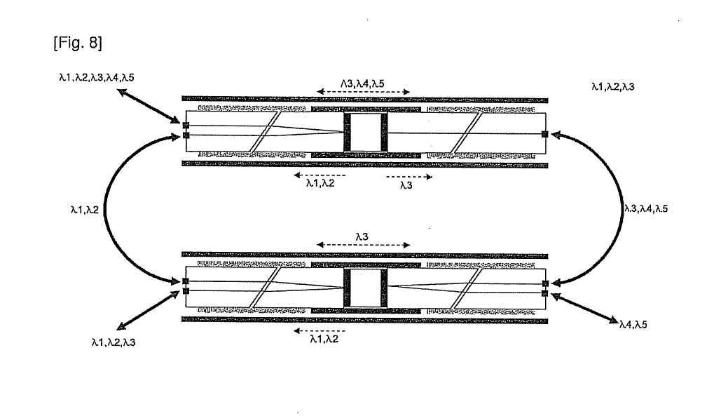

Here, for understanding, an example will be given wherein all the wavelengths λ1, λ2, λ3, λ4 and λ5 are input in the same direction and then output. In practice, the downlink transmission signals having the wavelengths λ2, λ3 and λ5 and the uplink transmission signals having the wavelengths λ1 and λ4 are transmitted in opposite directions, and thus, the input and the output thereof also occur in opposite directions. However, wavelength directionality is not important in describing the characteristics of the WDM coupler according to the present invention. Accordingly, for convenience of description and understanding, it will be assumed that the wavelengths are input through the same input/output port, and will also be equally applied to descriptions referring to FIGS. 7 and 8.

As a second characteristic, the WDM coupler according to the present invention provides the dual filtering structure so that the wavelengths λ1, λ2, λ3, λ4 and λ5 to be split into respective optical fibers are more reliably isolated. In other words, when the reflected wavelengths λ3, λ4 and λ5 are input to the thin film filter 750a, most optical intensities are primarily reflected and the other weak transmission signals are secondarily reflected from the thin film filter 750b, so that the transmission wavelengths λ1 and λ2 are more reliably isolated from the wavelengths λ3, λ4 and λ5, thereby providing excellent noise filtering characteristics.

Due to the dual filtering structure, the transmission wavelengths λ1 and λ2 have an additional insertion loss within 0.1 dB, but isolation characteristics are improved by 30 dB or more as compared with a single filter. Thus, in the configuration of the multiple passive optical network as shown in FIG. 2 or 3, the WDM coupler of FIG. 6 greatly improves isolation characteristics as compared with the general WDM coupler if the wavelength λ3 for the video overlay is included in the N-PON or is not in use.

FIG. 7 shows a WDM coupler according to another exemplary embodiment of the present invention.

The WDM couplers shown in FIG. 7 are structured for a case in which the wavelength λ3 (1550 nm) for the video overlay is assigned to the first PON as shown in FIG. 3.

A first WDM coupler has the same structure as shown in FIG. 6. The first WDM coupler includes a first thin film filter 850a which transmits the wavelength group λ1 and λ2 and a second thin film filter 850b which reflects the wavelength group λ3, λ4 and λ5 (see solid line 500 in FIG. 4). A second WDM coupler has the same structure as shown in FIG. 6 except that a single fiber collimator is provided at a side for combining only the transmission wavelength λ3. The second WDM coupler includes a third thin film filter 890a and a fourth thin film filter 890b which transmit only the wavelength λ3 disposed between the wavelengths λ4 and λ5 like the dotted line 600 illustrated in FIG. 4.

When mixed wavelengths λ1, λ2, λ3, λ4, λ5 are input to an input/output port 810, the long wavelengths λ3, λ4 and λ5 are reflected from the first thin film filter 850a and output to an input/output port 820, but the short wavelengths λ1 and λ2 are transmitted and output to an input/output port 830. When the long wavelengths λ3, λ4 and λ5 are input to an input/output port 860 of the second WDM coupler, only the wavelength λ3 for the video overlay is transmitted through the third and fourth thin film filters 890a and 890b and sent to the first WDM coupler via an input/output port 880, and the wavelengths λ4 and λ5 are reflected from the third thin film filter 890a and then output to an input/output port 870. The wavelength λ3 transmitted to the input/output port 840 of the first WDM coupler through the input/output port 880 is reflected from the fourth thin film filter 850b and then output along with the wavelengths λ1 and λ2 for the EPON/GPON to the input/output port 830.

FIG. 8 shows a WDM coupler according to a third exemplary embodiment of the present invention.

The WDM couplers shown in FIG. 8 are structured for the case in which the wavelength λ3 (1550 nm) for the video overlay is assigned to the first PON.

A first thin film filter 940a and a second thin film filter 940b of a first WDM coupler have transmission properties contrary to solid line 500 shown in FIG. 4. A third thin film filter 990a and a second thin film filter 990b of a second WDM coupler transmit only the wavelength λ3 for the video overlay but reflect the other wavelengths λ1, λ2, λ4 and λ5 like dotted line 600 shown in FIG. 4.

When mixed wavelengths λ1, λ2, λ3, λ4, λ5 are input to an input/output port 910, the short wavelengths λ1 and λ2 are reflected from the first thin film filter 940a and output to an input/output port 920, but the long wavelengths λ3, λ4 and λ5 are transmitted through the first and second thin film filters 940a and 940b and are then output to an input/output port 930. The wavelengths λ1 and λ2 incident to an input/output port 960 of the second WDM coupler are reflected from the third thin film filter 990a, and output to an input/output port 970. The wavelength λ3 for the video overlay among the long wavelengths λ3, λ4, λ5, which are incident to an input/output port 940, is transmitted through the fourth and third thin film filters 990b, 990a and is then output along with the wavelengths λ1 and λ2 through the input/output port 970. The wavelengths λ4 and λ5 are reflected from the fourth thin film filter 990b and output to the input/output port 980.

Although the present invention has been described with reference to the exemplary embodiments, it will be apparent to those skilled in the art that various modifications, additions and substitutions can be made without departing from the essential features of the invention. Therefore, it should be noted that the embodiments are given by way of illustration only and do not restrict the scope of the present invention. Further, the scope of the present invention is limited only by the accompanying claims, and many equivalent and alternative embodiments can exist within the scope of the present invention.

### INDUSTRIAL APPLICABILITY

The present invention can be effectively applied to an industrial field relating to a multiple passive optical network that is capable of offering a low speed/low data capacity service and a high speed/high data capacity service.

1. multiple passive optical network (PON) system comprising:
a first PON; and
a second PON which provides a service different in speed and capacity from the first PON but partially shares a network resource with the first PON.

2. The multiple PON system according to claim 1, wherein the first PON provides a low speed and low capacity service, and the second PON provides a high speed and high capacity service.

3. The multiple PON system according to claim 2, wherein the first PON comprises an Ethernet PON (EPON) or a gigabit-capable PON (GPON).

4. The multiple PON system according to claim 3, wherein the second PON comprises one of a 10G EPON, a 10G GPON, and a wavelength-division multiplexing (WDM) PON.

5. The multiple PON system according to claim 1,
wherein the first PON comprises at least one first optical line termination (OLT), a plurality of first optical network units (ONUs) corresponding to the first OLT, and a first remote node which branches a downlink transmission wavelength from the first OLT to the plurality of first ONUs and sends uplink transmission wavelengths from the plurality of first ONUs to the first OLT;
wherein the second PON comprises at least one second OLT, a plurality of second ONUs corresponding to the second OLT, and a second remote node which branches a downlink transmission wavelength from the second OLT to the plurality of second ONUs and sends uplink transmission wavelengths from the plurality of second ONUs to the first OLT; and
wherein an optical fiber is shared in at least one section between a side comprising the first OLT and the plurality of first ONUs corresponding to the first OLT and a side comprising the second OLT and the plurality of second ONUs corresponding to the second OLT to transmit and receive the uplink and downlink transmission wavelengths.

6. The multiple PON system according to claim 5, wherein the second PON comprises:
a first splitter/combiner which splits or combines the uplink and downlink transmission wavelengths to be transmitted and received in the first OLT and the uplink and downlink transmission wavelengths to be transmitted and received in the second OLT through the shared optical fiber, and
a second splitter/combiner which splits or combiners the uplink and downlink transmission wavelengths to be transmitted and received in the first ONUs and the uplink and downlink transmission wavelengths to be transmitted and received in the second ONUs through the shared optical fiber.

7. The multiple PON system according to claim 6, wherein each of the first splitter/combiner and the second splitter/combiner comprises at least one wavelength-division multiplexing (WDM) coupler.

8. The multiple PON system according to claim 7, wherein each of the first splitter/combiner and the second splitter/combiner comprises:
a dual filter comprising a first thin film filter and a second thin film filter, which are placed symmetrically to each other, to perform transmission and reflection depending on the wavelength;
two first input/output ports placed at a side of the first thin film filter; and
two second input/output ports placed at a side of the second thin film filter,
wherein the dual filter comprises a WDM coupler that transmits and reflects the uplink and downlink transmission wavelengths assigned to the first PON and the uplink and downlink transmission wavelengths assigned to the second PON, which are incident to the input/output ports, such that the uplink and downlink transmission wavelengths are output through the corresponding input/output ports to be split or combined.

9. The multiple PON system according to claim 7, wherein each of the first splitter/combiner and the second splitter/combiner comprises:
a first WDM coupler comprising a first dual filter comprising a first thin film filter and a second thin film filter, which are placed symmetrically to each other, to perform transmission and reflection depending on the wavelength, two first input/output ports placed at a side of the first thin film filter, and two second input/output ports placed at a side of the second thin film filter; and
a second WDM coupler comprising a second dual filter that comprises a third thin film filter and a fourth thin film filter, which are placed symmetrically to each other, to perform transmission and reflection depending on the wavelength, two third input/output ports placed at a side of the third thin film filter, and a fourth input/output port placed at a side of the fourth thin film filter,
wherein the input/output ports of the first WDM coupler and the input/output ports of the second WDM coupler are at least partially connected to each other, and the dual filter transmits and reflects the uplink and downlink transmission wavelengths assigned to the first PON, the uplink and downlink transmission wavelengths assigned to the second PON, and the wavelength for a video overlay assigned to either the first PON or the second PON, which are incident to the input/output ports, such that the wavelengths are output through the corresponding input/output ports to be split or combined.

10. The multiple PON system according to claim 6, further comprising:
a branching unit which branches a downlink transmission wavelength to each first splitter/combiner connected to two or more shared optical fibers, and sends a branched uplink transmission wavelength from each first splitter/combiner.

11. The multiple PON system according to claim 1,
wherein the first PON comprises at least one first optical line termination (OLT), a plurality of first optical network units (ONUs) corresponding to the first OLT, and a remote node which branches a downlink transmission wavelength from an OLT to a plurality of ONUs and sends uplink transmission wavelengths from the plurality of ONUs to the OLT; and
wherein the second PON comprises at least one second OLT, a plurality of second ONUs corresponding to the second OLT, a first splitter/combiner which splits or combines the uplink and downlink transmission wavelengths to be transmitted and received in the first OLT and the uplink and downlink transmission wavelengths to be transmitted and received in the second OLT, and a second splitter/combiner which splits and sends the downlink transmission wavelengths branched in the remote node to the first ONU and the second ONU, respectively, and combines and sends the uplink transmission wavelength received from the first ONU and the second ONU to the remote node.

12. The multiple PON system according to claim 11, wherein the first splitter/combiner and the second splitter/combiner comprise wavelength-division multiplexing (WDM) couplers, respectively.

13. The multiple PON system according to claim 12, wherein each of the first splitter/combiner and the second splitter/combiner comprises:
a dual filter comprising a first thin film filter and a second thin film filter, which are placed symmetrically to each other, to perform transmission and reflection depending on the wavelength;
two first input/output ports placed at a side of the first thin film filter; and
two second input/output ports placed at a side of the second thin film filter,
wherein the dual filter comprises a WDM coupler that transmits and reflects the uplink and downlink transmission wavelengths assigned to the first PON and the uplink and downlink transmission wavelengths assigned to the second PON, which are incident to the input/output ports, such that the uplink and downlink transmission wavelengths are output through the corresponding input/output ports to be split or combined.

14. The multiple PON system according to claim 12, wherein each of the first splitter/combiner and the second splitter/combiner comprises:
a first WDM coupler comprising a first dual filter that comprises a first thin film filter and a second thin film filter, which are placed symmetrically to each other, to perform transmission and reflection depending on the wavelengths, two first input/output ports placed at a side of the first thin film filter, and two second input/output ports placed at a side of the second thin film filter; and
a second WDM coupler comprising a second dual filter that comprises a third thin film filter and a fourth thin film filter, which are placed symmetrically to each other, to perform transmission and reflection depending on the wavelength, two third input/output ports placed at a side of the third thin film filter, and two fourth input/output ports placed at a side of the fourth thin film filter, wherein the input/output ports of the first WDM coupler and the input/output ports of the second WDM coupler are at least partially connected to each other, and the dual filter transmits and reflects the uplink and downlink transmission wavelengths assigned to the first PON, the uplink and downlink transmission wavelengths assigned to the second PON, and the wavelength for a video overlay assigned to either the first PON or the second PON, which are incident to the input/output ports, such that the wavelengths are output through the corresponding input/output ports to be split or combined.

15. The multiple PON system according to claim 11, further comprising:
a branching unit which branches a downlink transmission wavelength to each first splitter/combiner connected to two or more shared optical fibers, and sends a branched uplink transmission wavelength from each first splitter/combiner.

16. A wavelength splitter/combiner comprising:
a dual filter comprising a first thin film filter and a second thin film filter, which are placed symmetrically to each other, to perform transmission and reflection depending on the wavelength;
at least one first input/output port placed at a side of the first thin film filter; and
at least one second input/output port placed at a side of the second thin film filter,
wherein the dual filter comprises a wavelength-division multiplexing (WDM) coupler that transmits and reflects uplink and downlink transmission wavelengths assigned to a first passive optical network (PON) and uplink and downlink transmission wavelengths assigned to a second PON different from the first PON, which are incident to the input/output ports, such that the uplink and downlink transmission wavelengths are output through the corresponding input/output ports to be split or combined.

17. A wavelength splitter/combiner comprising:
a first wavelength-division multiplexing (WDM) coupler comprising a first dual filter that comprises a first thin film filter and a second thin film filter, which are placed symmetrically to each other, to perform transmission and reflection depending on the wavelength, at least one first input/output port placed at a side of the first thin film filter, and at least one second input/output port placed at a side of the second thin film filter; and
a second WDM coupler comprising a second dual filter that comprises a third thin film filter and a fourth thin film filter, which are placed symmetrically to each other, to perform transmission and reflection depending on the wavelength, at least one third input/output port placed at a side of the third thin film filter, and at least one fourth input/output port placed at a side of the fourth thin film filter,
wherein the input/output ports of the first WDM coupler and the input/output ports of the second WDM coupler are at least partially connected to each other, and the dual filter transmits and reflects uplink and downlink transmission wavelengths assigned to a first passive optical network (PON), uplink and downlink transmission wavelengths assigned to a second PON different from the first PON, and a wavelength for a video overlay assigned to either the first PON or the second PON, which are incident to the input/output ports, such that the wavelengths are output through the corresponding input/output ports to be split or combined.
